(19) United States
(12) Patent Application Publication
(10) Pub. No.: US 2021/0023937 A1
(43) Pub. Date: Jan. 28, 2021

(54) AIR FLOW CONTROL DEVICE FOR A FRONT FACE MODULE OF A MOTOR VEHICLE

(71) Applicant: Valeo Systemes Thermiques, Le Mesnil-Saint-Denis (FR)

(72) Inventors: Sylvain Gerber, Le Mesnil Saint-Denis (FR); Enzo Mitidieri, Le Mesnil Saint-Denis (FR); Stephan Andre, Le Mesnil Saint Denis (FR)

(73) Assignee: Valeo Systemes Thermiques, Le Mesnil-Saint-Denis (FR)

(21) Appl. No.: 16/969,717

(22) PCT Filed: Feb. 4, 2019
(86) PCT No.: PCT/FR2019/050240

§ 371 Date: Aug. 13, 2020

(30) Foreign Application Priority Data
Feb. 13, 2018 (FR) 1851188

(51) Int. Cl. B60K 11/08

(52) U.S. Cl. CPC B60K 11/085

(57) ABSTRACT

The invention relates to an air flow control device (500) for a front face module of a motor vehicle, the control device (500) comprising: •—a plurality of flaps (1i), each rotatable about an axis of rotation (100i). According to the invention, the axes of rotation (100i) of the flaps (1i) are aligned in at least two different planes of alignment.

The field of the present invention is that of the thermal treatment of different zones or components of a motor vehicle. More specifically, the present invention relates to the cooling units that are used to this end, and it more particularly relates to the devices that are used to modulate the circulation of an air flow within such units.

The use of movable flaps is known, for example, flaps that are placed on the front face of the vehicle, in particular in order to reduce the drag coefficient of a motor vehicle. Such movable flaps, the movements of which are, for example, governed by an actuator connected to an electric drive motor, also allow the cooling and/or air-conditioning performance capabilities within the vehicle to be improved. More generally, such movable flaps allow the circulation of an air flow to be controlled that is intended to pass through one or more elements arranged in an engine compartment of the vehicle.

Such devices are preferably placed on a front grille of the relevant motor vehicle, and are known using the acronym AGS for “Active Grille Shutter”. In the open position of the movable flaps of such devices, air can circulate through the grille and particularly help to cool the engine of the vehicle, for example, by passing through one or more heat exchangers of a cooling unit of the vehicle. In the closed position of the movable flaps of such devices, the circulation of air through the grille is blocked, which reduces the drag of the vehicle, thus allowing the fuel consumption and, in particular, the emission of carbon dioxide to be reduced

An AGS device as described above therefore allows, as long as the engine of the vehicle does not need to be cooled with the outside air, the energy consumption of the vehicle and the pollution generated thereby to be reduced. In a known manner, in the closed position, the movable flaps of such devices together form a substantially flat surface.

The development of the design and the ongoing concern for reducing the pollution generated by the motor vehicles nevertheless generates increasingly complex and significant constraints in terms of material, in particular, of bulk and of the installation of the components of the motor vehicles, sometimes making it impossible to install a conventional AGS device as described above.

Therefore, the technical problem resides in the installation of a device for controlling the passage of an air flow intended to pass through one or more components of a cooling unit of a motor vehicle, in an environment in which it is impossible to install an AGS device as known in the prior art. The components of the cooling unit intended to be passed through by the aforementioned air flow can be, in a non-exhaustive manner, a front grille of the considered vehicle, one or more heat exchangers, and/or any other element of a unit for cooling one or more elements of the vehicle.

In order to achieve its aim, the subject matter of the invention is an air flow control device for a front face module of a motor vehicle, the control device comprising:

a plurality of flaps, each being rotatable about an axis of rotation.

According to the invention, the axes of rotation of the flaps are contained in at least two distinct planes.

In other words, the air flow control device, viewed as a profile view, is configured so that all the axes of rotation of the flaps are not all aligned in the same plane, or on a single straight line. In other words, viewed as a profile view, all the axes of rotation of the flaps are aligned on at least 2 distinct straight line segments.

More specifically, the control device according to the invention is such that the axes of rotation of the flaps are contained in at least three distinct alignment planes. In other words, the air flow control device, viewed as a profile view, is configured so that all the axes of rotation of the flaps are aligned on at least 3 distinct straight line segments.

Still according to the invention, if the control device comprises N flaps, then the axes of rotation of the flaps are all contained in at least 2, 3 or 4 distinct planes, even up to N−1 distinct planes.

In other words, the control device corresponds to a set of flaps for a front face module, in other words a cooling unit, of a motor vehicle, the set of flaps comprising at least:

a plurality of flaps, each of which is rotatable about an axis substantially parallel to a main extension direction of the flap, and passing through a junction zone of the flap and a structural element of the vehicle, whether this is a housing of the cooling unit or a structural wall of the vehicle;

a common drive plate for rotating each flap about the axis of rotation thereof, the plate being connected to each flap by means of guide pads respectively arranged on each flap at a first longitudinal end.

According to the invention, the axes of rotation of the flaps are arranged together on a non-flat surface.

A front face module is understood herein to be a cooling unit intended to cool the engine and/or the car interior of this vehicle. The cooling unit comprises a frame or chassis, inside which, in a non-exhaustive manner, one or more heat exchangers, a grille of the vehicle, one or more heat transfer fluid circuits, etc. can be housed.

Other embodiments according to the invention taken individually or in combination propose that:
the flaps are inscribed in a curved or bent surface;
the flaps are inscribed in a concave surface;
the device further comprises a common drive plate for simultaneously rotating each flap about their respective axis of rotation, each flap being connected to the common drive plate;
the common drive plate comprises secondary openings, each of which is configured to receive a pin for connecting a flap;
a plurality of secondary openings is oblong shaped;
the main extension directions of the secondary openings are not parallel to each other;
the secondary openings have, in their main extension direction, different dimensions;
the common drive plate comprises a main opening configured to receive a finger of an actuator for controlling the movements of the common drive plate;
the main opening is oblong shaped;
the device comprises a frame having bearings, in which the flaps can be introduced, the frame having a curved profile.

The invention also relates to a front face module comprising such an air flow control device. The invention also relates to a motor vehicle, in which such an air flow control device and such a front face module are installed.

According to one feature of the invention, a set of flaps comprises a plurality of mutually identical flaps, all assembled on the common drive plate to form the set of flaps according to the invention.

According to the invention, each flap is in the general form of a blade or a thin panel extending in a main extension direction, also denoted hereafter as longitudinal direction of the considered flap. With reference to the aforementioned longitudinal direction, the transverse direction of a flap is defined as the direction that defines, with the previously defined longitudinal direction, the active surface of the flap, i.e. the surface of the flap intended to be placed in an air flow in order to modify or not modify the flow before it reaches a cooling unit of the vehicle. The vertical direction of the flap is also defined as the direction perpendicular both to the previously defined longitudinal direction and to the transverse direction of the flap, with the vertical direction consequently defining the thickness of the flap.

For each of the flaps of the assembly according to the invention, the previously defined longitudinal direction, transverse direction and vertical direction together form a direct trihedron. For flow reasons, as well as for reasons associated with the installation and/or manufacturing constraints, each flap can have a substantially convex shape in the transverse direction thereof. The vertical direction of a flap in this case will be defined as being that in which the thickness of the blade forming the considered flap extends at the apex of the curvature of the convex shape. It is to be noted that, in all cases, the aforementioned vertical direction can, for each flap of the set of flaps according to the invention, have any orientation relative to the vertical direction of the vehicle.

According to the invention, each flap is rotatable about an axis of rotation substantially parallel to the longitudinal direction, i.e. to the main extension direction, of this flap. More specifically, each flap of the set of flaps according to the invention can move between a first closed end position, and a second open end position, between which it can assume all the intermediate angular positions about the axis of rotation thereof. It is thus possible to define, on the one hand, a closed position of the set of flaps according to the invention, in which the flaps forming this set are simultaneously all in their closed position and, on the other hand, an open position of the set of flaps according to the invention, in which the flaps forming this set are simultaneously all in their open position.

It must be understood herein that, within the set of flaps according to the invention, all the flaps are advantageously, at each instant, in the same relative angular position relative to their previously defined axis of rotation. In other words, in the set of flaps according to the invention, all the flaps are simultaneously rotated by the same angle about their respective axis of rotation.

In the closed position of the set of flaps according to the invention, the flaps of this set together form a substantially continuous surface. More specifically, this substantially continuous surface is configured to block the passage of an air flow through the set of flaps according to the invention. By way of a non-limiting example, the closed position of the set of flaps according to the invention can correspond to a substantially zero angular rotation of each of the flaps about the axis of rotation thereof, with the angular position corresponding to the closed position of each of the flaps then being defined as the initial angular position for measuring the angle of rotation of these flaps.

In the open position of the set of flaps according to the invention, the flaps of this set authorize the passage of an air flow through the set of flaps according to the invention, without significantly modifying the flow. By way of a non-limiting example, the open position of the set of flaps according to the invention can correspond to an angular rotation of the order of 90° of each of the flaps about the axis of rotation thereof, with the angle of rotation being measured from an arbitrarily defined initial angular position.

Between their open position and their closed position, the flaps of the set of flaps according to the invention can assume all the intermediate angular positions, such that, when placed in an air flow that is intended to pass through them, the set of flaps according to the invention modulates the flow of such an air flow to a greater or lesser extent.

Advantageously, the flaps of the set of flaps according to the invention are assembled so that their respective axes of rotation are, to the nearest manufacturing and assembly tolerances, substantially parallel to each other. In other words, the flaps of the set according to the invention are assembled so that their longitudinal directions are all parallel to each other, without being coincident. The longitudinal direction of the set of flaps according to the invention is then defined as any of the longitudinal directions of each of the flaps of this set, with these all being parallel to each other.

In the set of flaps according to the invention, the flaps are assembled so that, in the previously defined closed position of this set of flaps, they are placed substantially side-by-side along their longitudinal edges. According to one feature of the invention, the flaps can have a flexible lip on these longitudinal edges. In this way, the flaps can be arranged in the aforementioned closed position, the flaps are advantageously disposed so that a space remains between two adjacent flaps that is sufficient to allow each of these flaps to rotate, whilst preventing, in the closed position of each of these flaps, the passage of any air flow.

In order to perform simultaneous rotation of all the flaps, the set of flaps according to the invention comprises the common drive plate. According to the invention, the common drive plate is a complex shaped part that is substantially flat and is arranged, in the set of flaps according to the invention, substantially perpendicular, to the nearest manufacturing and assembly tolerances, to the previously defined longitudinal direction of the set of flaps according to the invention, i.e. substantially perpendicular to the direction of the axes of rotation of each of the flaps, with these being, as previously indicated, all parallel to each other.

According to the invention, each of the flaps is connected, at one of the ends thereof in the longitudinal direction thereof, to the common drive plate, via at least one guide pad, so that a movement thereof simultaneously causes a corresponding movement of all the flaps of the set according to the invention.

More specifically, each of the flaps is connected, at one of the ends thereof in the longitudinal direction thereof, on the one hand, to a structural element, for example, the chassis or the frame of the front face module, or the housing of the cooling unit or even a support frame having bearings, in which the flaps are introduced, in particular the axes of rotation of the flaps, also called journals, and, on the other hand, to the common drive plate. The movement of the plate causes the movement of the connection point of each flap on the plate and therefore causes the respective pivoting of these flaps about the fixed point of rotation formed by the junction zone of the flap and the structural element.

Furthermore, according to the invention, the flaps are arranged so that the axes of rotation thereof together form a non-flat surface. In other words, the intersection points of the axis of rotation of each of the flaps with the structural element, respectively the guide pins of the flaps engaging with the plate, are arranged on a curve that is not a straight line, unlike the sets of movable flaps as known from the prior art. It follows that, in the closed position of the set according to the invention, i.e. when the flaps of this set are all in their closed position, the substantially continuous surface that they together form is a complex surface and not a flat surface. This particularly increases the possibilities of installing such a set of flaps in vehicle environments that have specific design and/or bulk constraints, thus achieving the stated aim of the invention.

Advantageously, the invention also has one or more of the following features, taken individually or in combination:

the common drive plate comprises a plurality of secondary openings, each of which is configured to receive a pin for connecting a movable flap. In other words, the connection zone between each flap of the set of flaps according to the invention and the common drive plate comprises a secondary opening arranged in the common drive plate and a pin arranged at one of the ends, in the longitudinal direction thereof, of the considered flap. Advantageously, each of these pins substantially extends in the main extension direction of the corresponding flap, i.e. substantially in the longitudinal direction of the considered flap, i.e. still substantially in the direction of the axis of rotation of this flap. Advantageously, the common drive plate comprises at least as many secondary openings as the set of flaps according to the invention comprises flaps;

the common drive plate comprises a main opening configured to receive a finger of an actuator for controlling the movements of the common drive plate. The movements of the common drive plate can be governed by an electric motor, via an actuator rotated by this electric motor and in turn driving the movement of the common drive plate. More specifically, the actuator comprises an eccentric finger engaged in the main opening so that the implementation of the actuator generates a rotation movement of the finger about the axis of rotation of the actuator, and therefore a rotation movement of the common drive plate, about an axis substantially parallel to the axes of rotation of the flaps of the set according to the invention. With each of these flaps being, at one of the ends thereof and in the longitudinal direction thereof, connected to the common drive plate, the result of the above is that the rotation movement, about an axis substantially parallel to the axes of rotation of each of the flaps, of the common drive plate, in turn drives a rotation movement of each of the flaps about its previously defined axis of rotation. A simultaneous rotation movement of all the flaps of the set of flaps according to the invention about their axes of rotation is thus simply performed, by means of a single movement of the actuator. Advantageously, the invention stipulates that the finger of the actuator, engaged in the main opening of the common drive plate in order to rotate said plate, is substantially parallel to the common direction of the axes of rotation of the various flaps, i.e. to the main directions of extension of each of the flaps of the set of flaps according to the invention, i.e. still to the previously defined longitudinal direction of the set of flaps according to the invention;

a plurality of previously defined secondary openings is oblong shaped. Advantageously, each oblong-shaped secondary opening extends in a main extension direction located in the plane of the common drive plate. The oblong shape of these secondary openings arranged in the common drive plate is dictated by the complex shape thereof and by the complex shape of the surface formed by all the axes of rotation of each of the flaps of the set of flaps according to the invention. This oblong shape particularly allows, when the common drive plate is rotated by the previously defined actuator, simultaneous rotation of all the flaps to be provided, through different movements of each of the corresponding pins within the corresponding secondary opening. More specifically, when the common drive plate is rotated, the pins of each of the flaps of the set of flaps according to the invention are caused to move, in the main extension direction of the corresponding secondary opening, between the edges thereof. To this end, the respective dimensions of the aforementioned pins and secondary openings are advantageously defined so that the clearance between the edges of each secondary opening and the corresponding pin is minimal, so as to ensure that this pin is guided by these edges. Advantageously, the direction and the amplitude of this movement are defined by the location of the axis of rotation of the considered flap in the complex surface formed by the axes of rotation of the flaps of the set according to the invention. It is to be understood herein that the dimension of each secondary opening in the main extension direction thereof is defined so that, in the first closed end position of the set according to the invention, the pin engaged in this secondary opening is located at one of the ends, in this main extension direction, of this secondary opening, and so that this pin is located, in the second open end position of the set according to the invention, at the opposite end of this secondary opening in the main extension direction thereof;

the secondary openings are arranged in series, from a first end of the plate to a second opposite end, with the secondary openings disposed at the ends of the series that have a circular shape, with dimensions that are adjusted to those of the guide pad of the corresponding flap, whereas the other secondary openings have an oblong shape as previously defined. In this way, a clearance is allowed during movement of the plate and the resulting drive of the flaps on the oblong-shaped openings, and the movement of the plate is controlled for each opening and closing operation by the presence of the circular shaped openings;

the main extension directions of the secondary openings are not all parallel to each other. This directly results, on the one hand, from the above, i.e. from the complex shape of the surface formed by the axes of rotation of the flaps of the set according to the invention and from the location of the axis of rotation of each of the flaps within this complex surface and, on the other hand, from the simultaneous rotational drive, according to the same angular value relative to their respective axes of rotation, of all the flaps;

the previously defined main opening, arranged in the common drive plate, is oblong. Advantageously, the main opening extends in a main extension direction located in the plane of the common drive plate. As well as the oblong shape of each of the previously defined secondary openings, the oblong shape of the main opening arranged in the common drive plate is dictated by the complex shape thereof and by the complex shape of the surface formed by all the axes of rotation of each of the flaps of the set of flaps according to the invention. This oblong shape particularly allows the finger of the actuator to slide when the common drive plate is rotated by the previously defined actuator, and to thus allow simultaneous rotation of all the flaps according to the same angular value relative to their respective axes of rotation. The clearance allows smooth rotation of the common drive plate, and therefore without blocking the opening and closing movement of the flaps. More specifically, when the common drive plate is rotated by the previously defined actuator, the previously defined finger of this actuator is caused to rotate and tends to bear against one of the edges of this main opening. The thrust that is produced by the finger generates a movement for rotating the plate about a theoretical axis parallel to the main extension direction of the flaps, or longitudinal direction. To this end, the respective dimensions of the actuator finger and of the main opening are advantageously defined so that the clearance between the edges of the main opening and the actuator finger is minimal, so as to guarantee immediate guidance of said actuator finger by these edges;

the theoretical axis of rotation of the plate is defined by the arrangement of the axes of rotation of the flaps and of the axes of rotation of the guide pads in the secondary openings of the plate. It is understood that, in order to regularly reproduce the position of the theoretical axis of rotation, the secondary openings arranged at the end of the series of openings are not oblong shaped, as has been previously stated;

the set of flaps according to the invention comprises a common retention plate. The common retention plate has a similar shape to that of the common drive plate and it is advantageously placed, in the set of flaps according to the invention, at the end of the flaps opposite the end through which each of these flaps is connected to the common drive plate. However, unlike the common drive plate, which causes, through the movements thereof, the flaps to rotate, the common retention plate is caused to move by the rotation movements of the flaps of the set of flaps according to the invention. The common retention plate is not motorized and only fulfills a function of guiding the flap to thus ensure that the flaps do not deform during movement;

each of the flaps of the set of flaps according to the invention is connected to the common retention plate, at the second longitudinal end of the flap, as well as to a structural element, and, for example, a wall of the housing of the cooling unit;

the common retention plate comprises a plurality of oblong openings, each of which is configured to receive a lug arranged substantially longitudinally at the end of one of the flaps. In other words, each flap of the set of flaps according to the invention is connected to the common retention plate by a retention zone, which comprises an oblong opening configured to receive a lug arranged, substantially in the longitudinal direction of the considered flap, at the end of this flap. The result of the above is that the common retention plate guarantees a certain amount of uniformity of the rotation movement of each flap over the entire longitudinal dimension thereof. In particular, the presence of the common retention plate ensures that the rotation movement of each flap is not accompanied by any twisting thereof;

all the axes of rotation of each flap are aligned along a curved or bent plane. In other words, the air flow control device 500, viewed as a profile view, is such that the axes of rotation are aligned along an alignment curve of the axes of rotation that can be concave or convex depending on the volume constraints within the engine compartment. It is also possible to contemplate an embodiment where the alignment curve of the axes of rotation can have an inflection point. In other words, the flaps are arranged in a non-flat surface having a point of curvature.

Further features, details and advantages of the invention will become more clearly apparent from reading the following description, which is provided by way of an illustration and with reference to the drawings, in which:

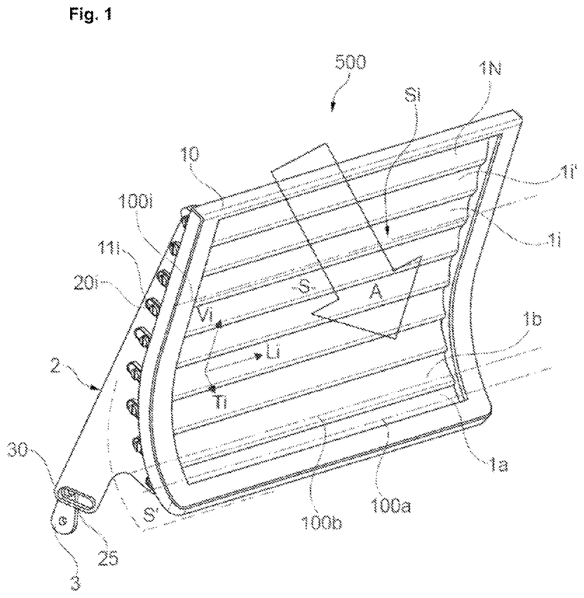

FIG. 1 is a schematic perspective view of a set of flaps according to the invention, in the closed position thereof;

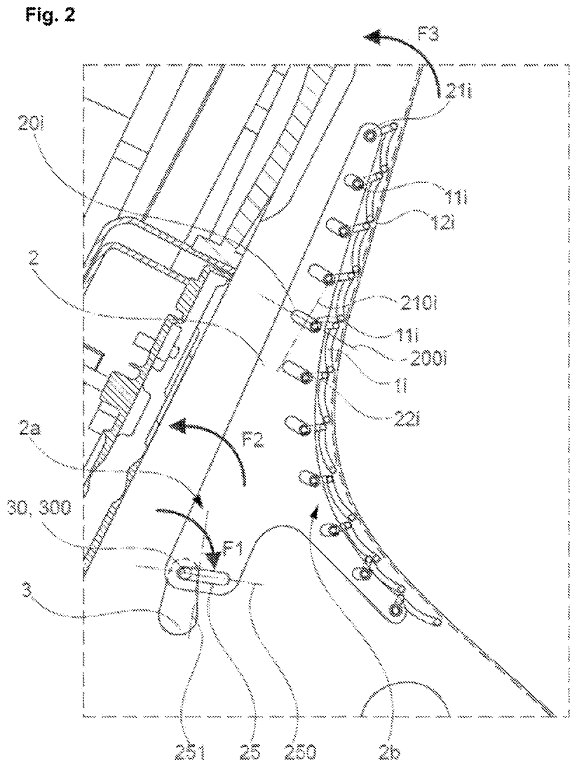

FIG. 2 is a schematic view, of the side of the common drive plate, of a set of flaps according to the invention, in the closed position thereof;

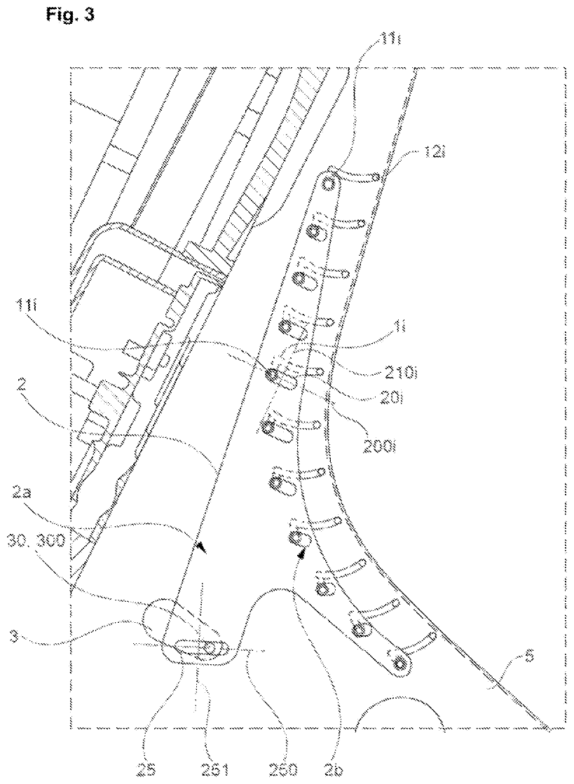

and FIG. 3 is a schematic view, of the side of the common drive plate, of a set of flaps according to the invention, in the open position thereof.

Firstly, it is to be noted that although the figures disclose the invention in detail for the implementation thereof, said figures clearly can be used to better define the invention if necessary. It is also to be noted that the same elements are denoted using the same reference signs throughout all the figures.

With reference to FIG. 1, an air flow control device 500 according to the invention can comprise a support frame 10 having N bearings or even the actual chassis of the front face module, into which N flaps 1a, 1b, . . . 1N are inserted, with each flap being rotatable about an axis of rotation, respectively 100a, 100b, . . . 100N. Hereafter, the generic designation 1i will be used for any one of the flaps 1a, 1b, . . . 1N, with it being understood that the flaps 1a, 1b, . . . 1N all individually have the same features relative to the invention. Therefore, the detailed description of the flap 1i that will be provided will be valid for all the flaps 1a, . . . 1N of the air flow control device 500 according to the invention.

The air flow control device 500 according to the invention is intended to be placed in an air flow, shown by the arrow A in FIG. 1, in order to modulate the flow as a function of the position of the flaps 1a, . . . 1N relative to the flow direction of an air flow A. The air flow control device 500 according to the invention can be intended to be placed between an air intake of a motor vehicle, not shown in the figures, and a cooling unit of the vehicle, not shown in the figures, or even can be placed at the outlet of the cooling unit, between said unit and the elements of the vehicle to be cooled. According to various embodiments, the cooling unit can be, in a non-limiting manner, a heat exchanger of a coolant circuit, or any other element of a heat transfer fluid circuit intended to cool one or more components of the considered vehicle.

With reference to FIG. 1, a flap 1i of the air flow control device 500 according to the invention is in the general shape of a blade or of a thin panel extending in a main extension direction Li, also denoted hereafter as longitudinal direction Li of the flap 1i. With reference to the longitudinal direction Li, the transverse direction Ti of the flap 1i is defined as the direction which, with the aforementioned longitudinal direction Li, defines an active surface Si of the flap 1i. An active surface Si is defined herein as the surface of the flap 1i intended to be placed in the aforementioned air flow A in order to modulate the flow as a function of the relative orientation of the surface Si relative to the direction of the air flow A. According to the non-limiting embodiment, more particularly illustrated in the figures, the flap 1i has, in the transverse direction Ti thereof, a substantially convex shape, for which the apex of the curvature is oriented opposite the aforementioned air flow A. In addition to the longitudinal Li and transverse Ti directions of the flap 1i, a vertical direction Vi of the flap 1i is defined that is perpendicular both to the aforementioned longitudinal direction Li and to the transverse direction Ti.

According to the embodiment that is more particularly illustrated in FIG. 1, the vertical direction Vi will be defined as being the direction along which the thickness of the flap 1i extends at the apex of the curvature of the convex shape assumed by this flap in the transverse direction Ti thereof. For each flap 1i, the longitudinal direction Li, the transverse direction Ti and the vertical direction Vi form a direct trihedron (Li, Ti, Vi) that is shown in FIG. 1.

It is clear from FIG. 1 that, in the air flow control device 500 according to the invention, the flaps 1i are assembled such that their longitudinal directions Li are all substantially parallel to each other, to the nearest manufacturing and assembly tolerances. More specifically, it is clear from FIG. 1 that the flaps 1i are stacked to form the air flow control device 500 according to the invention, such that their longitudinal directions Li, which are substantially parallel to each other, are not coincident to each other. Hereafter, the longitudinal direction of the air flow control device 500 according to the invention will denote any one of the aforementioned longitudinal directions Li.

According to the invention, each flap 1i is rotatable about an axis of rotation 100i substantially parallel to the longitudinal direction Li of this flap 1i. The result of the above is that the axes of rotation 100i of the various flaps 1i of the air flow control device 500 according to the invention are all, to the nearest manufacturing and assembly tolerances, distinct from each other and are substantially parallel to each other.

Each flap 1i of the air flow control device 500 according to the invention can move between a first closed end position and a second open end position, between which it can assume all the intermediate angular positions relative to the axis of rotation 100i thereof. It is to be noted that, according to the invention, all the flaps 1i are, at each instant, in the same relative angular position relative to their respective axes of rotation 100i. In other words, in the air flow control device 500 according to the invention, all the flaps 1i are simultaneously rotated by the same angle about their respective axes of rotation 100i.

FIGS. 1 and 2 more specifically show the air flow control device 500 according to the invention in the closed position for all the flaps 1i forming this set. This position is also called the closed position or configuration of the air flow control device 500. In this position, it is clear from FIG. 1 that the previously defined active surfaces Si of the flaps 1i together form a substantially continuous surface S. As shown in FIG. 1, the substantially continuous surface S is configured to prevent the passage of the previously defined air flow A through the air flow control device 500 and it has a curvature that is adapted to the integration of the set of flaps in the motor vehicle.

In other words, each flap 1i is rotatable about an axis of rotation 100i and is configured to transition from a configuration or position, called open or opening configuration or position, of the frame 10 where each flap 1i opposes the passage of the air flow through the opening defined by the frame 10 as little as possible, to a configuration or position, called closed or closing or sealing configuration or position, of the frame 10 where each flap 1i opposes the flow of the air flow as much as possible, with the set of flaps 1i preventing the air flow from passing through the opening of the frame 10.

In other words, the various flaps 1i are arranged within the air flow control device 500 such that, in the closed position thereof, they are placed substantially side-by-side along their longitudinal edges. The angular position of each flap 1i about the axis of rotation 100i thereof in the closed position of the considered flap will be arbitrarily denoted as 0 degrees.

In the open position of the flaps 1i, shown in FIG. 3 and also denoted open position of the air flow control device 500 according to the invention, the flaps 1i authorize the passage of an air flow A through the air flow control device 500 without significantly modifying the flow of this air flow. With reference to the previously defined angular position, corresponding to the closed position of each flap 1i, the angular position of each flap 1i about the axis of rotation 100i thereof, in the open position of the considered flap 1i, could be, by way of a non-limiting example, of the order of 90 degrees.

Between the open position of the air flow control device 500 according to the invention and its closed position, the flaps 1i forming this set can assume all the intermediate angular positions relative to their respective axes of rotation, in order to modify the amount of air passing through the air flow control device 500 and, therefore, to modulate the air flow A passing through said air flow control device 500.

According to the invention, the axes of rotation 100i of the various flaps 1i of the air flow control device 500, which are substantially parallel to each other, to the nearest manufacturing and assembly tolerances, as previously indicated, are together inscribed in a non-flat surface S′, more particularly a curved or bent surface S′. In other words, the flaps 1i and the panels of the flaps 1i together define a substantially curved surface formed by a plurality of flat segments corresponding to each flap 1i. Correspondingly, the pins disposed at the ends of the flaps to engage with the corresponding plate are arranged so that the centers of these pins define a curved line following the curvature assumed by all the flaps in the closed position.

According to an embodiment in which each flap 1i is substantially flat in the transverse direction Ti thereof, the aforementioned surface S′ is substantially parallel to the previously defined substantially continuous surface S, which is formed, in the closed position of the air flow control device 500 according to the invention, by all the previously defined active surfaces Si. According to the embodiment illustrated by FIGS. 1 and 2, in which each flap has, in the transverse direction Ti thereof, a convex shape, the aforementioned surface S′ could, by way of a non-limiting example, be substantially parallel to the surface formed by the various tangents at the apex of the convex shape of each flap 1i.

Such an arrangement has a major difference from the sets of movable flaps that are known from the prior art, in which the axes of rotation of the various flaps together define a plane, to the nearest manufacturing and assembly tolerances. The arrangement according to the invention particularly allows the air flow control device 500 according to the invention to be installed in vehicle environments in which the bulk is significantly limited, for example. Such an arrangement also opens up significant design possibilities. Indeed, an air flow control device 500 according to the invention can be placed on the front face of the vehicle, for example, on a curved grille thereof or even inside the front compartment in order to bypass constituent elements of this compartment.

As shown in the figures, the air flow control device 500 according to the invention also comprises a common drive plate 2. The common drive plate 2 is a complex, substantially flat part that is arranged substantially perpendicular, to the nearest manufacturing and assembly tolerances, to the previously defined longitudinal direction L of the air flow control device 500, i.e. also substantially perpendicular to the axes of rotation moi of the flaps 1i forming this set. According to the particularly advantageous, but not exclusive, embodiment of the invention that is illustrated by the figures, the common drive plate 2 is in the general shape of an arc comprising an activation portion 2a forming a heel projecting from a guide portion 2b defining the arc shape. The guide portion is substantially concave over its entire length, with its curvature being oriented opposite the activation portion 2a.

In the illustrated example, a curved gap is provided between the heel of the activation portion and an end of the guide portion forming an arc, in this case to minimize the bulk and the weight of the device.

According to the invention, each flap 1i of the air flow control device 500 is connected, at one of the ends thereof in the previously defined longitudinal direction Li thereof, on the one hand, to a structural element 5, for example, the housing of the cooling unit, to define a fixed axis of rotation of the flap and, on the other hand, to the common drive plate 2, in order to produce, by means of this plate, the drive about the fixed rotation point. In this way, a movement of said common drive plate simultaneously causes a rotation of each of the flaps 1i by the same angular value about the axis of rotation moi thereof.

FIGS. 2 and 3 provide a more detailed illustration of a longitudinal end of the set of flaps according to the invention, on the side of the common drive plate 2, revealing the connection of each of the flaps 1i to the common drive plate 2 and to the structural element 5, on the one hand, and the connection of the common drive plate to a motorized drive device, on the other hand. FIG. 2 more particularly illustrates the closed position of an air flow control device 500 according to the invention and FIG. 3 more particularly illustrates the open position of such an assembly.

The common drive plate 2 comprises a main opening 25 configured to receive a finger 30 of an actuator 3 for controlling the movements of the common drive plate 2. As illustrated, the main opening 25 can be arranged in the heel of the previously defined activation portion of the common drive plate 2.

According to a particularly advantageous, but not exclusive, embodiment of the invention, the finger 30 of the control actuator 3 has a substantially cylindrical shape and assumes an eccentric position so that the axis 300 thereof is parallel to the axis of rotation 30 of the actuator 3 and is substantially perpendicular, to the nearest manufacturing and assembly tolerances, to the plane of the common drive plate 2.

According to the invention, the main opening 25 is, in the plane of the common drive plate 2, oblong shaped, the largest dimension of which extends in a main extension direction 250, and the lateral dimension of which, which extends, in the plane of the common drive plate 2, in a lateral direction 251 perpendicular to the aforementioned main extension direction 250, is only slightly greater than a diameter of the finger 30 of the actuator 3. More specifically, the invention stipulates that the lateral dimension of the main opening 25 is defined so that any movement of the finger 30 of the actuator 3, in the plane of the common drive plate 2, relative to the main opening 25, generates an immediate contact against the lateral edges of the main opening 25, tending to push the plate, which generates a rotation movement thereof. In other words, the relative dimensions of the finger 30 and of the main opening 25 are defined so that the only relative movement that these two elements can have one relative to the other is a movement of the finger 30 along the main extension direction 250 of the main opening 25, guided by the lateral edges thereof.

Each flap comprises, on the one hand, a finger 12i intended to be mounted in a bearing supported by the structural element, to form a fixed axis of rotation specific to each flap and, on the other hand, means for connecting each of the flaps 1i with the common drive plate 2. This connection is produced by engaging a pin 11i, supported by the flap 1i and distinct from the finger, in a corresponding secondary opening 20i arranged on the common drive plate 2.

For a given flap, the finger 12i and the pin 11i are arranged at the end of the flap 1i by which said flap is connected to the common drive plate 2, substantially in the longitudinal direction Li of this flap, i.e. also in the direction of the axis of rotation 100i of the considered flap 1i. More specifically, each pin 11i and each finger 12i form a longitudinal protuberance at the end of the corresponding flap 1i. According to a particularly advantageous, but not exclusive, embodiment of the invention, these pins 11i and these fingers 12i have a substantially cylindrical shape, the axis of which is parallel to the aforementioned longitudinal direction Li.

According to the non-limiting embodiment illustrated by the figures, the secondary openings 20i are advantageously arranged in the vicinity of the curved edge of the previously defined guide portion.

The secondary openings are arranged in the plane of the common drive plate 2, and in series along the curved edge, from a first end of the guide portion up to a second opposite end. A distinction should be made, as shown in FIGS. 2 and 3, from the first secondary openings 21i, which have a circular shape with dimensions that are substantially equal to those of the pins that are compelled to be housed in these openings, and second secondary openings 22i, which are oblong shaped. Thus, for each second secondary opening 22i, on the one hand, a main extension direction 200i is defined, into which the largest dimension of the considered secondary opening 20i extends, and, on the other hand, a lateral direction 210i is defined that is perpendicular, in the plane of the common drive plate 2, to the aforementioned main extension direction 200i.

According to the invention, the lateral dimension of each second secondary opening 22i, i.e. the dimension of each second secondary opening 20i in the aforementioned lateral direction 210i thereof, is defined so that the lateral clearance of the pin 11i intended to be engaged in this second secondary opening 20i is minimal. In other words, the lateral dimension of each second secondary opening 22i is only slightly greater than the diameter of the pin 11i intended to be engaged in this secondary opening, in such a way that any movement of the common drive plate 2 generates an immediate contact of the pin against the lateral edges of the second secondary opening, which helps to move the flaps at the same time as the movement of the plate. In other words, the relative dimensions of the pins 11i and of the corresponding second secondary openings 22i are defined so that the only relative movement that a pin 11i can make, relative to the second secondary opening 20i in which it is engaged, is a movement along the main extension direction 200i of this second secondary opening 20i, guided by the lateral edges thereof.

It follows that any rotation movement of the common drive plate 2 about an axis substantially perpendicular to the plane in which it extends, generates the rotation, about said axis, of a pin 11i engaged in a corresponding second secondary opening 20i. Such a rotation, which leads to a movement of the pin 11i not only directed in the main extension direction 200i of the considered secondary opening 20i, will lead to the simultaneous combination of a movement of the pin 11i in the aforementioned main extension direction 200i, within said second secondary opening 20i, and a rotation movement, about the axis of rotation moi thereof, of the corresponding flap 1i. As previously described, the first secondary openings have a circular shape with dimensions that are adjusted to those of the corresponding pin in order to guarantee a repeatable movement of the corresponding flaps as a function of the movement of the common drive plate 2 and the oblong shape of the second secondary openings allows the clearance caused by the simultaneous movement of all the flaps to be managed.

Advantageously, the common drive plate 2 comprises at least as many secondary openings 20i as the air flow control device 500 according to the invention comprises flaps 1i.

FIG. 2 illustrates the air flow control device 500 according to the invention in the closed position thereof, i.e. in the previously defined closed position, of all the flaps 1i that form this set. In this position, the finger 30 of the actuator 3, engaged in the previously defined main opening 25, is advantageously placed at one of the ends, in the previously defined main extension direction 250, thereof. In this position, and as is also shown in FIG. 2, each pin 11i of the flaps 1i of the air flow control device 500, engaged in a corresponding secondary opening 20i, is advantageously placed at one end of this secondary opening 20i in the main extension direction 200i thereof.

When the actuator 3 is rotated by an electric motor 4, not shown in the figures, about the previously defined axis of rotation 300, it causes the previously defined finger 30 to rotate about a center provided on the actuator, in a direction of rotation illustrated by the arrow F1 in FIG. 2. Then, the result of the previously mentioned dimensions of the finger 30 of the actuator 3 and of the main opening 25 arranged in the common drive plate 2 is that, under the effect of this rotation, the finger 30 rotates the drive plate in the direction of rotation illustrated by the arrow F2, about an instantaneous center of rotation, the theoretical position of which is inside the curve of the plate, by pushing against the lateral edges of the main opening. The oblong shape of this opening allows the finger to move between the edges of the main opening 25 in the main extension direction 250 thereof, in order to manage the assembly clearances of the various moving pails.

The rotation of the common drive plate 2 in the direction illustrated by the arrow F2 leads to a rotation in the same direction, illustrated by the arrow F3, of the secondary openings 20i arranged in the common drive plate 2. Then, the result of the previously described relative configuration of the pins 11i of the flaps 1i and of the secondary openings 20i and, in particular, of the dimensions of these pins relative to the dimensions, in the lateral direction 210i, of each of the secondary openings 20i, is that the rotary movement of the common drive plate 2 generates the rotation, in the same direction, of each of the aforementioned pins 11i, which rotation leads to the rotation, in the direction of rotation illustrated by the arrow F3, of each corresponding flap 1i.

These various movements continue until the air flow control device 500 according to the invention has reached its previously defined open position, illustrated in FIG. 3. In this position, each pin 11i of a flap 1i is placed at the end of the opposite secondary opening 20i, in the previously defined main extension direction 200i, at the end of which this pin is placed when the air flow control device 500 according to the invention is in the closed position thereof. Furthermore, in the open position of the air flow control device 500, the finger 30 of the actuator 3 is placed in an intermediate position in the main opening 25 between the two ends.

From reading FIGS. 2 and 3 it will be understood that the finger 30 is disposed at a first end of the main opening in the closed position and that it is disposed at the opposite second end when the finger has made a 90° rotation. In the example illustrated in FIG. 3, the open position of the set is such that the finger has rotated by an angle with a value that is greater than 90° and the finger has therefore made a partial movement from the second end that it reached after the 90° rotation.

It is to be noted in FIGS. 2 and 3 that the main extension directions 200i of the secondary openings 20i are not parallel to each other, and that the secondary openings 20i do not all have the same dimension in their respective main extension directions 200i.

These various features are dictated, on the one hand, by the complex shape of the surface S′ formed by all the axes of rotation 100i of the flaps 1i of the air flow control device 500 according to the invention and, on the other hand, by the desire for simultaneous rotation, by the same angular value, of the flaps 1i during a movement of the common drive plate 2.

Indeed, according to the particularly advantageous, but not exclusive, embodiment of the invention, illustrated by the figures, the main opening 25 is arranged in the heel forming the previously defined activation portion 2a of the common drive plate 2, with the secondary openings 20i being arranged along the edge of the guide portion. The secondary openings are all located at different distances from the main opening 25 of the common drive plate 2 and, therefore, at different distances from the finger 30 of the actuator 3 and from the axis of rotation 300 thereof.

It follows that the same angular rotation value of the flaps 1i about their axis of rotation 100i does not lead to the same movement, between the edges of the corresponding secondary opening 20i, of the corresponding pin 11i, as a function of the location of the considered secondary opening 20i relative to the main opening 25.

Furthermore, the result of the previously defined complex shape of the surface S′ formed by all the axes of rotation 100i of the flaps 1i is that the main extension directions 200i of the secondary openings 20i are not parallel to each other. This particularly allows the flaps 1i of the air flow control device 500 according to the invention, which have, in a closed position of the set, a different incline from one flap to the next, to all be simultaneously rotated by the same angular value about their own axis of rotation 100i.

The air flow control device 500 according to the invention also advantageously comprises a common retention plate, not shown in the figures. With a similar shape to that of the common drive plate 2, the substantially flat common retention plate is placed opposite the common drive plate 2 in the previously defined longitudinal direction L of the air flow control device 500 according to the invention. More specifically, the common retention plate is connected to each of the flaps 1i of the air flow control device 500 according to the invention, and it is arranged, in the aforementioned longitudinal direction L, opposite the end of these flaps by which said flaps are connected to the common drive plate 2.

In order to complete its connection with each of the flaps 1i of the air flow control device 500 according to the invention, the common retention plate comprises a plurality of connection openings 50i, each of which is configured to receive a lug of a flap 1i. Each lug extends substantially longitudinally at the end of the flap 1i on which it is placed. According to a preferred, but not exclusive, embodiment of the invention, each lug has a substantially cylindrical shape, the axis of which, to the nearest manufacturing and assembly tolerances, is parallel to the axis of rotation 100i of the considered flap 1i.

Like the common drive plate 2, each connection opening, arranged in the plane of the common retention plate, is oblong shaped. Thus, for each connection opening, on the one hand, a main extension direction is defined, in which the largest dimension of the considered connection opening extends, and, on the other hand, a lateral direction is defined that is perpendicular, in the plane of the common retention plate, to the aforementioned main extension direction.

The shape of the common retention plate is similar to that of the common drive plate 2, but the common retention plate is not motorized, i.e. it is not rotated by an actuator of an electric motor. In this case, it is the flaps 1i of the air flow control device 500 according to the invention that, when rotated by the movement of the common drive plate 2, which is rotated by the actuator 3, in turn cause the common retention plate to rotate substantially parallel to the common drive plate 2, to the nearest manufacturing and assembly tolerances.

Therefore, the common retention plate particularly ensures that the rotation movement of each flap 1i is even over the entire dimension, in the longitudinal direction Li of said flap 1i, without twisting. The common retention plate also helps to stiffen and strengthen the air flow control device 500 according to the invention.

The control device 500 according to the invention can comprise a frame 10 having bearings, into which the flaps are introduced, with the frame 10 having a curved profile. In other words, the shape of the frame 10, viewed from the side, is curved.

The invention definitely achieves its stated aims by allowing, by implementing the air flow control device 500 as it has been described and illustrated, simple modulation of an air flow intended to be routed toward a cooling unit of a motor vehicle. By virtue of its features, the air flow control device 500 according to the invention also can be installed in an environment having significant spatial requirement constraints.

The invention as described above nevertheless is not limited to the exclusively described and illustrated means and configurations, and is also applicable to all equivalent means or configurations and to any combination of such means or configurations. In particular, the invention is also applicable in the event whereby the common drive plate 2 and/or the common retention plate have different zones extending in substantially different planes, which may or may not be parallel to each other.

1. An air flow control device for a front face module of a motor vehicle, said control device comprising:
a plurality of flaps, each being rotatable about an axis of rotation,
wherein the axes of rotation of the flaps are contained in at least two distinct planes.

2. The control device as claimed in claim 1, wherein the flaps are inscribed in a curved surface.

3. The control device as claimed in claim 1, further comprising: a common drive plate for simultaneously rotating each flap about their respective axis of rotation, each flap being connected to the common drive plate.

4. The control device as claimed in claim 3, wherein the common drive plate comprises secondary openings, each of which is configured to receive a pin for connecting a flap.

5. The control device as claimed in claim 4, wherein the secondary openings are oblong shaped.

6. The control device as claimed in claim 4, wherein the main extension directions of the secondary openings are not parallel to each other.

7. The control device as claimed in claim 4, wherein the secondary openings have, in their main extension direction, different dimensions.

8. The control device as claimed in claim 3, wherein the common drive plate comprises a main opening configured to receive a finger of an actuator for controlling the movements of the common drive plate.

9. The control device as claimed in claim 8, wherein the main opening is oblong shaped.

10. The control device as claimed in claim 1, comprising a frame having a curved profile.

11. An air flow control device for a front face module of a motor vehicle, said control device comprising:
a plurality of N flaps, each of the N flaps being rotatable about an axis of rotation, wherein the axes of rotation of the N flaps are all contained in N−1 distinct planes.

12. An air flow control device for a front face module of a motor vehicle, said control device comprising:
a plurality of flaps, each of which is configured to rotate about an axis of rotation substantially parallel to a main extension direction of each flap, and passing through a junction zone of each flap and a structural element of the vehicle,
wherein the axes of rotation of the plurality of flaps is contained in at least three distinct alignment planes.
